(19) United States
(12) Patent Application Publication
(10) Pub. No.: US 2024/0131561 A1
(43) Pub. Date: Apr. 25, 2024

(54) CONTACT CLEANING APPARATUS

(71) Applicant: Illinois Tool Works Inc., Glenview, IL (US)

(72) Inventors: Sheila HAMILTON, Glasgow (GB); Stephen MITCHELL, Glasgow (GB)

(21) Appl. No.: 18/547,451

(22) PCT Filed: Feb. 25, 2022
(86) PCT No.: PCT/US2022/018005

§ 371 Date: Aug. 21, 2023

(30) Foreign Application Priority Data
Mar. 3, 2021 (GB) 2102969.9
Feb. 2, 2022 (GB) 2201326.2

(51) Int. Cl. B08B 1/50; B08B 1/32; G01N 21/94; G01N 21/952

(52) U.S. Cl. CPC B08B 1/50; B08B 1/32; G01N 21/94; G01N 21/952

(57) ABSTRACT

The present invention relates to a contact cleaning apparatus (100) including an elastomeric roller (120), rotatably mounted within a contact cleaning apparatus such that an outer surface (123) of said elastomeric roller contactingly engages a substrate surface (112) during use. There is also provided an apparatus for evaluating said outer surface of said elastomeric roller, including an electromagnetic radiation source (140), configured to selectively emit electromagnetic radiation of a predetermined electromagnetic spectrum onto at least one predetermined region (125) of said outer surface, a detector (160), configured to receive at least a first reflection of said electromagnetic radiation from said at least one predetermined region, and a controller (270) operably coupled to said detector and adapted to determine at least one characteristic parameter of at least said first reflection. The present invention also relates to a method of evaluating a contact cleaning apparatus, including evaluating an elastomeric roller surface using electromagnetic radiation.

### FIELD OF THE DISCLOSURE

The present invention relates to an apparatus for evaluating a contact cleaning apparatus, in particular, for evaluating an elastomeric roller surface, such as a surface roughness thereof, using electromagnetic radiation. The present invention also relates to a method of evaluating a contact cleaning apparatus, particularly evaluating an elastomeric roller surface, such as a surface roughness thereof, using electromagnetic radiation.

### INTRODUCTION

Contact cleaning is used to clean substrate surfaces. Once cleaned, the substrate surface may be used in a variety of sophisticated processes such as in the manufacturing of components for electronics, photovoltaics and flat panel displays. These substrate surfaces must be thoroughly cleaned so that contaminants do not degrade or compromise the component. A cleaning roller, usually a rubber or elastomeric roller, is used to remove contaminating particles from a substrate surface. An adhesive roll can then be used to remove the contaminating particles or debris from the elastomeric roller. This allows the elastomeric roller surface to maximise its efficiency in removing contaminating particles from the substrate surface.

Certain known elastomeric rollers have a surface that may be microscopically roughened, into which contaminating particles are received from the contaminated substrate surface. However, the maintenance of contact cleaning apparatus can be difficult with the removal and replacement of the elastomer rollers being time consuming and/or requiring partial disassembly of the apparatus.

One of the drawbacks of the solutions according to the prior art is that, during use, the elastomeric roller wears as its surface contacts the contaminated substrate surface. Due to the critical nature of the cleaning in component processing, cleaning efficiency should be maintained. Furthermore, when cleaning efficiency is significantly degraded then the elastomeric roller should be replaced. However, as the elastomeric roller is used, wear of its surface occurs which impacts cleaning efficiency. In known systems, a degradation in cleaning efficiency may only be noticed due to impairment of later processing steps, reducing overall process efficiency.

Currently known devices may include an optical dopant within a surface or core region of a cleaning roller which luminesces, phosphoresces or fluoresces to enable the thickness of the surface region to be determined. However, such a device relies on measuring the quantity of optical dopant within a region and, furthermore, cannot provide a direct analysis of the outer surface of the elastomeric roller surface.

Changes in the elastomeric roller surface during use provide further problems in processes where the substrate is pliable or flexible, such as, where the substrate is a film. Wear of the roller surface changes the adhesion forces between an elastomeric roller and the substrate surface and may cause wrapping of the substrate around the roller. As a result, the machine must be stopped in order to cleanse the roller of the substrate and then restart the machinery. Again, the efficiency of the cleaning process is significantly impaired.

Consequently, it is an object of the present invention to mitigate some of the aforementioned disadvantages. In particular, it is an object of the invention to monitor the outer surface of an elastomeric roller. That is, it is desirable to determine whether an elastomeric roller outer surface retains the ability to provide effective cleaning. In particular, it is desirable to monitor the outer surface in a non-contact manner.

A further object is to provide apparatus capable of monitoring an elastomeric roller surface to ensure its cleaning performance is above a predetermined threshold.

A yet further object of the invention is to monitor the surface roughness of an outer surface of an elastomeric. In particular, it is desirable to ensure the surface roughness remains above a predetermined threshold.

### SUMMARY OF THE INVENTION

According to an aspect of the invention, there is provided an apparatus for evaluating an elastomeric roller surface, including:
an elastomeric roller, rotatably mounted within a contact cleaning apparatus such that an outer surface of said elastomeric roller contactingly engages a substrate surface;
an electromagnetic radiation source, configured to selectively emit electromagnetic radiation of a predetermined electromagnetic spectrum onto at least one predetermined region of said outer surface,
and a detector, configured to receive at least a first reflection of said electromagnetic radiation from said at least one predetermined region.

In certain embodiments, a controller is operably coupled to said detector and adapted to determine at least one characteristic parameter of at least said first reflection.

According to an aspect of the invention, there is provided a contact cleaning apparatus, including:
an elastomeric roller, rotatably mounted within said contact cleaning apparatus such that an outer surface of said elastomeric roller is contactingly engageable with a substrate surface; and
an apparatus for evaluating said outer surface of said elastomeric roller, including:
   an electromagnetic radiation source, configured to selectively emit electromagnetic radiation of a predetermined electromagnetic spectrum onto at least one predetermined region of said outer surface;
   a detector, configured to receive at least a first reflection of said electromagnetic radiation from said at least one predetermined region; and
   a controller operably coupled to said detector and adapted to determine at least one characteristic parameter of at least said first reflection.

In certain embodiments, said first reflection, or indeed any further reflection(s), is a reflection received by said detector directly from said at least one predetermined region of said outer surface.

In certain embodiments, said at least one characteristic parameter is a radiation scattering characteristic of at least said first reflection from said at least one predetermined region.

In certain embodiments, said radiation scattering characteristic corresponds to, or is representative of, or is characteristic of, or is indicative of, a surface roughness of said elastomeric roller, particularly said outer surface thereof.

In certain embodiments, said controller is adapted to determine a surface roughness of said elastomeric roller, particularly said outer surface thereof, based upon said at least one characteristic parameter of at least said first reflection.

In certain embodiments, said controller is adapted to monitor a surface roughness of said elastomeric roller, particularly said outer surface thereof, based upon a plurality of reflections. That is, said controller may be adapted to determine at least one characteristic parameter of each of a plurality of reflections, and monitor a surface roughness based upon said characteristic parameters of said plurality of reflections. That is, said controller may be adapted to monitor said at least one characteristic parameter of each reflection, and to monitor a surface roughness of said elastomeric roller, particularly said outer surface thereof, based upon the monitoring of said characteristic parameters.

In certain embodiments, said controller is adapted to monitor said at least one characteristic parameter and actuate an alarm signal when said at least one characteristic parameter deviates by a predetermined threshold.

In certain embodiments, said controller is adapted to monitor said characteristic parameter continuously.

In certain embodiments, said predetermined threshold is a maximum deviation from an initial value of said at least one characteristic parameter.

In certain embodiments, said controller is further adapted to determine said at least one characteristic parameter from an intensity of at least said first reflection of said electromagnetic radiation from said at least one predetermined region.

In certain embodiments, said apparatus is operable to emit said electromagnetic radiation onto a plurality of predetermined regions of said outer surface.

In certain embodiments, said controller is adapted to provide an average of said predetermined characteristic parameter determined from at least a first reflection from each of said plurality of different regions.

According to an aspect of the invention, there is provided a method of evaluating an outer surface of elastomeric roller, said method including:
providing an electromagnetic radiation source,
providing a detector,
using said electromagnetic radiation source to selectively emit electromagnetic radiation of a predetermined electromagnetic spectrum onto a predetermined region of said outer surface, and
using said detector to detect at least a first reflection from said predetermined region.

In certain embodiments, a method further includes providing a controller, and using said controller to determine at least one characteristic parameter of at least said first reflection.

According to an aspect of the invention, there is provided a method of evaluating an outer surface of an elastomeric roller for a contact cleaning apparatus, said method including:
using an electromagnetic radiation source to selectively emit electromagnetic radiation of a predetermined electromagnetic spectrum onto a predetermined region of said outer surface;
using a detector to detect at least a first reflection from said predetermined region; and
using a controller to determine at least one characteristic parameter of at least said first reflection.

In certain embodiments, said first reflection, or indeed any further reflection(s), is a reflection received by said detector directly from said at least one predetermined region of said outer surface.

In certain embodiments, said at least one characteristic parameter is a radiation scattering characteristic of at least said first reflection from said at least one predetermined region.

In certain embodiments, said radiation scattering characteristic corresponds to, or is representative of, or is characteristic of, or is indicative of, a surface roughness of said elastomeric roller, particularly said outer surface thereof.

In certain embodiments, the method includes the step of using the controller to determine a surface roughness of said elastomeric roller, particularly said outer surface thereof, based upon said at least one characteristic parameter of at least said first reflection.

In certain embodiments, the method includes the step of using said controller to monitor a surface roughness of said elastomeric roller, particularly said outer surface thereof, based upon a plurality of reflections. That is, the step may include using said controller to monitor said at least one characteristic parameter of each of a plurality of reflections, and to monitor a surface roughness of said elastomeric roller, particularly said outer surface thereof, based upon the monitoring of said characteristic parameters.

In certain embodiments, the method includes the step of actuating an alarm signal in response to said at least on characteristic parameter deviating by a predetermined threshold.

According to an aspect of the invention, there is provided a contact cleaning apparatus including:
an elastomeric roller rotatably mounted within said contact cleaning apparatus such that an outer surface of said elastomeric roller is contactingly engageable with a substrate surface, and
an apparatus for evaluating a surface roughness of said outer surface of said elastomeric roller, comprising:
   an electromagnetic radiation source, configured to selectively emit electromagnetic radiation of a predetermined electromagnetic spectrum onto at least one predetermined region of said outer surface;
   a detector, configured to receive at least a first reflection of said electromagnetic radiation from said at least one predetermined region; and
   a controller operably coupled to said detector, said controller adapted to determine, based upon at least said first reflection, a surface roughness of said outer surface.

According to an aspect of the invention, there is provided a method of evaluating a surface roughness of an outer surface of an elastomeric roller, said method comprising:
using an electromagnetic radiation source to selectively emit electromagnetic radiation of a predetermined electromagnetic spectrum onto a predetermined region of said outer surface;
using a detector to detect at least a first reflection from said predetermined region; and
using a controller to determine a surface roughness of said outer surface based upon at least one characteristic parameter of at least said first reflection.

As will be apparent to the person skilled in the art, the various aspects of the invention disclosed herein are interchangeable, and the associated specific features are applicable across the various aspects disclosed without departing from the described invention.

Certain examples provide the advantage that the cleaning efficiency of an outer surface of an elastomeric roller is analysed directly. That is, the cleaning efficiency directly relates to a characteristic parameter of the reflection from the outer surface of electromagnetic radiation. Furthermore, the outer surface is analysed in a non-contact manner.

Certain examples provide the advantage that an outer surface is continuously monitored. In this way, the performance of cleaning operation can be monitored within a multi-step processing apparatus.

Continuous monitoring of cleaning performance ensures that any reduction of performance below a threshold is detected before it has an impact on the surface substrate or subsequent processing steps. Thus, processing of a substrate surface is maintained without impairment due to optimal cleaning efficiency.

Furthermore, by continuously analysing cleaning performance it may be possible to determine or predict when cleaning performance will fall below a threshold, or will no longer be optimal. Replacement of the elastomeric roller can then be coordinated to occur at a convenient time, such during scheduled maintenance.

Certain examples provide the advantage that an outer surface can be monitored in light of the substrate surface being cleaned. In other words, a threshold cleaning performance is set according to the substrate surface being cleaned. In this way, for example, the monitoring of an outer surface used to clean a deformable or pliable substrate will have a threshold which actuates an alarm before there is a risk of film wrapping around the roller. Thus, outer surface wear is monitored so that an elastomeric roller is promptly renewed before the substrate surface or the cleaning apparatus is damaged.

Certain examples provide the advantage that the roughness of the outer surface is monitored. Consequently, the outer surface is monitored so that its roughness remains above a threshold. In this way it is possible to ensure that as the surface wears, an alarm is actuated before there is a substantial risk of thin film substrates becoming wrapped around the roller. The surface roughness of the outer surface is monitored so that an elastomeric roller is promptly renewed before a substrate surface or the cleaning apparatus is damaged.

### BRIEF DESCRIPTION OF THE DRAWINGS

Embodiments of the invention are now described, by way of example only, hereinafter with reference to the accompanying drawings, in which:

FIG. 1. shows a schematic view of a contact cleaning apparatus in accordance with an aspect of the invention;

FIG. 2. shows a schematic view of another contact cleaning apparatus in accordance with an aspect of the invention;

FIG. 3. shows a schematic view of a yet further contact cleaning apparatus in accordance with an aspect of the invention

FIG. 4. shows a schematic view of another contact cleaning apparatus in accordance with an aspect of the invention.

In the drawings, like reference numerals refer to like parts.

### DETAILED DESCRIPTION

Certain terminology is used in the following description for convenience only and is not limiting. The words ‘inner’, ‘inwardly’ and ‘outer’, ‘outwardly’ refer to directions toward and away from, respectively, a designated centreline or a geometric centre of an element being described (e.g. central axis), the particular meaning being readily apparent from the context of the description.

Further, as used herein, the terms ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

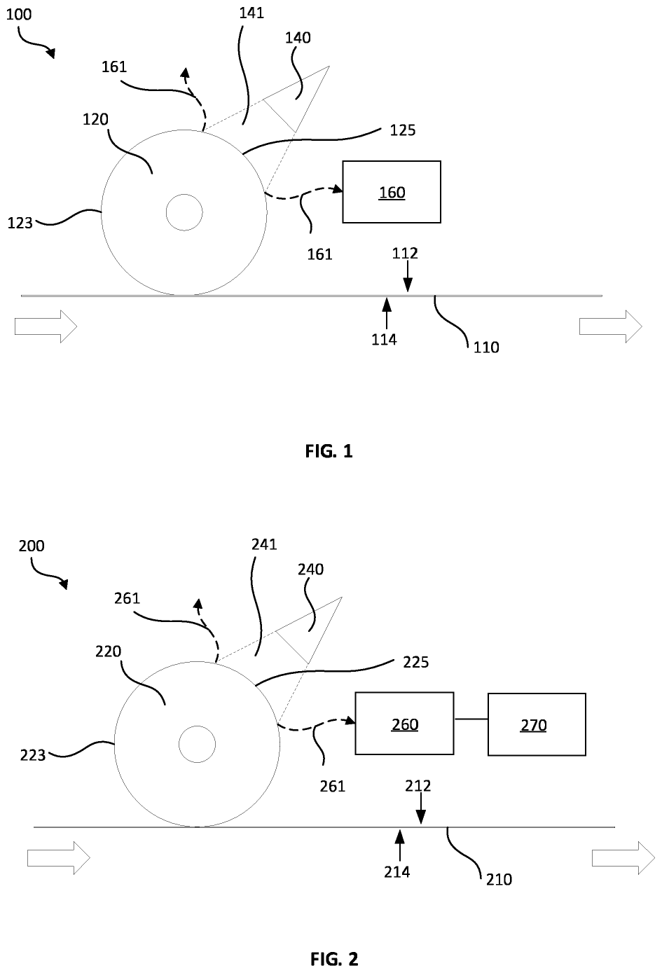

Referring now to FIG. 1, there is shown a general apparatus according to an aspect of the invention. An elastomeric roller 120 rotatably mounted within a contact cleaning apparatus 100 so that the outer surface 123 of the elastomeric roller contactingly engages a first substrate surface 112. An electromagnetic radiation source 140 selective emits electromagnetic radiation 141 of a predetermined electromagnetic spectrum onto a region 125 of the outer surface 123, and a detector 160 is configured to receive a reflection 161 of the electromagnetic radiation from the region 125.

The electromagnetic radiation source 140 is arranged to emit electromagnetic radiation 141 onto a predetermined region 125 of the outer surface. In the example shown in FIG. 1, the predetermined region 125 extends partially around the circumference of the elastomeric roller 120 and along a portion of it axial length. The electromagnetic radiation source 140 remains fixed relative to the elastomeric roller 120. In this way, electromagnetic radiation 141 is emitted onto a fixed predetermined region 125 of the elastomeric roller 120 as its outer surface 123 rotates through the predetermined region 125.

The electromagnetic radiation source 140 is a light emitting diode (LED) emitting electromagnetic radiation 141. In the example shown, the LED emits visible light, in this example red light, onto the predetermined region 125.

The detector 160 is provided adjacent to the surface region 125 exposed to electromagnetic radiation 141. The detector 160 is arranged to receive a reflection 161 of the electromagnetic radiation 141 from the surface region 125. In this way a proportion of the electromagnetic radiation reflection 161 from the surface region 125 is received and collected by the detector 160.

In alternative arrangements, the electromagnetic radiation source 140 may be configured to emit electromagnetic radiation onto a plurality of predetermined regions of the outer surface 123. The predetermined regions may be arranged at any suitable position around or across the elastomeric roller 120. The predetermined regions may be arranged at any suitable circumferential orientation or along the axial length of the elastomeric roller 120.

In alternative arrangements, such as the example of FIG. 4 described herein, the electromagnetic radiation source may be adapted to move relative to the elastomeric roller, for example by moving axially or circumferentially with respect to the elastomeric roller. Thus, the electromagnetic radiation source may be adapted to scan the elastomeric roller, for example by scanning around or along the elastomeric roller. In this way, the electromagnetic radiation source can emit radiation onto a plurality of predetermined regions of the outer surface. The radiation can be emitted continuously while scanning or can be emitted at discrete intervals. For example, the electromagnetic radiation source may traverse in a direction parallel to the elastomeric roller 120 axial length so as to emit electromagnetic radiation onto a series of indexed regions 125 across the outer surface of the elastomeric roller 120.

In any arrangement of the electromagnetic radiation source or sources, a detector or a plurality of detectors may be suitably arranged to receive a reflection from one or more regions of the outer surface 123 being irradiated by the electromagnetic radiation source. In particular, where an electromagnetic radiation source is adapted to scan the elastomeric roller, a detector may be adapted to move correspondingly. In this way, the detector may be a scanning detector.

In these ways, the electromagnetic radiation source and detector may be configured to provide analysis of any suitable proportion of the elastomeric roller 120 outer surface 123. That is, the apparatus may be configured to provide analysis of a representative region of the outer surface, either continuously or with a predetermined time interval. Alternatively, the apparatus may be configured to provide analysis of the whole outer surface 123 using reflections from a series of predetermined regions of the outer surface 123.

In use, the cleaning apparatus 100 is configured to convey the sheet substrate 110 in the direction indicated by the arrows of FIG. 1. The sheet substrate 110 is conveyed by one or more known driving means, such as, for example, a conveyor belt or a number of driven process rollers (not shown) suitably positioned before, within and/or after the cleaning apparatus 100. Additionally, the sheet substrate 110 may be conveyed by driving rotation of the elastomeric roller 120. The elastomeric roller 120 may be driven by using a direct drive system or may be driven due to the rotational engagement with a driven adhesive roll.

The sheet substrate 110 is received by the elastomeric roller 120 such that a first surface 112 of the sheet substrate 110 contacts the outer surface 123, also known as a cleaning surface, of the elastomeric roller 120. Due to the propensity of the elastomeric roller 120 outer surface 123 to collect contaminants, they are removed from the first surface 112 as the elastomeric roller 120 rotates.

The elastomeric roller 120 rotates so that the outer surface 123 moves away from the sheet substrate. A portion of the outer surface 123 rotates towards and then into the predetermined region 125. When the portion of the outer surface 123 is within the predetermined region 125 it is irradiated with electromagnetic radiation 141 from the radiation source 140.

The electromagnetic radiation is emitted onto the predetermined region 125 of the outer surface 123 causing electromagnetic radiation to be reflected therefrom. A proportion of the electromagnetic radiation 141 reflected from the predetermined region 125 is received by the detector 160. That is a reflection 161 is received by the detector 160.

The reflection 161 is reflected from the outer surface 123 such that a characteristic parameter of the electromagnetic radiation 141 is imparted to the reflection 161 due to the outer surface 123. In this way, the reflection 161 provides a direct, rather than indirect, analysis of the outer surface 123.

The detector 160 is adapted to continuously receive a reflection 161 of the electromagnetic radiation 141 from the predetermined region 125 of the outer surface 123. Thus, the apparatus provides a real-time analysis of the outer surface 123.

As mentioned above, a series of detectors may be arranged around or across the elastomeric roller 120 providing an analysis of the relative cleaning performance of individual predetermined regions of the outer surface 123. Consequently, the series of detectors provides comparative reflections from the predetermined regions such that a variation from one predetermined region to another may be an indication that the elastomeric roller 120 no longer provides optimal cleaning efficiently of a sheet substrate 110.

Referring now to FIG. 2, there is shown a second example apparatus 200 according to an aspect of the invention. Where the features are the same as the previous example, the reference numbers are also kept the same, but with a “2” as the initial digit. In the example of FIG. 2, the elastomeric roller 220, electromagnetic radiation source 240 and detector 260 are substantially the same as in the example of FIG. 1. The cleaning system 200 further includes a controller 270 operably coupled to the detector 260 and adapted to determine at least one characteristic parameter of a reflection 261 from the predetermined portion 225 of the outer surface 223 of the elastomeric roller 220.

In the example of FIG. 2, the electromagnetic radiation source 240 is a red LED which emits electromagnetic radiation with emitted intensity having a peak at a wavelength of 660 nm. The detector 260 is adapted to determine a reflected intensity, that is the detector measures the intensity of the reflection at a corresponding wavelength.

The controller 270 is configured, in use, to compare the reflected intensity to the emitted intensity. The comparison of the emitted and reflected intensity provides a measure of the surface roughness of the predetermined portion 225 of the outer surface 223.

When the elastomeric roller 220 is first installed in the contact cleaning apparatus, the controller 270 performs an initial comparison of the emitted and reflected intensities to determine an initial surface roughness of the outer surface 223. The controller 270 performs subsequent comparisons to monitor the surface roughness while the elastomeric roller 220 is in operation. When the monitored surface roughness deviates from the initial roughness by a predetermined threshold then the controller 270 actuates an alarm.

Alternatively, an initial surface roughness may be omitted. In this case the predetermined threshold may be suitably set as the surface roughness corresponding to an optimal cleaning efficiency.

The detector 270 is adapted to continuously receive a reflection 261 of electromagnetic radiation 241 from the outer surface 223. In this way, the controller 270 is configured to continuously compare the deviation of the measured surface roughness from the initial surface roughness. Thus, the apparatus 200 thus provides a real-time analysis of the outer surface 223 and actuates an alarm when that the surface roughness deviates from an optimal efficiency by a predetermined amount.

In these ways, the apparatus is able to monitor an elastomeric roller and actuate an alarm before there is a risk of a substrate wrapping around the roller. Consequently, the elastomeric roller will be promptly renewed before the substrate surface or the cleaning apparatus is damaged.

In other examples, the controller 270 may also be adapted to calculate an average, or an average deviation, of the surface roughness. The average may be determined from a series of reflections from one predetermined region of the outer surface, or from a number of reflections from a series of predetermined regions extending across the outer surface, as provided by the various arrangements of electromagnetic radiation sources and detectors described above in respect of the example of FIG. 1.

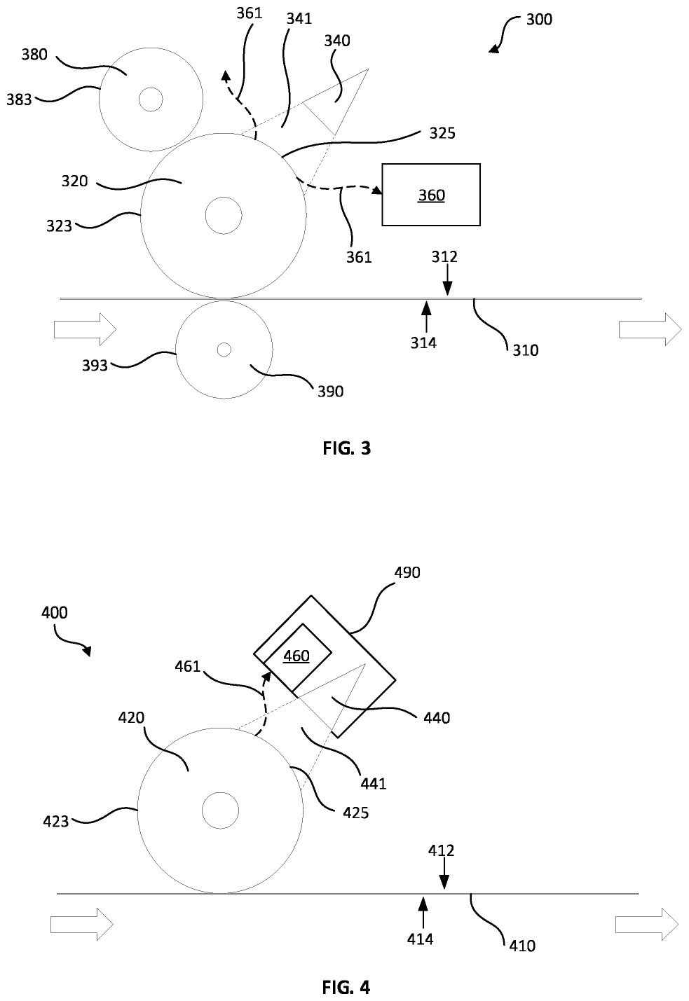

Referring now to FIG. 3, there is shown a third example apparatus 300 according to an aspect of the invention. Where the features are the same as the previous examples, the reference numbers are also kept the same, but with a “3” as the initial digit. In the example of FIG. 3, the elastomeric roller 320, electromagnetic radiation source 340 and detector 360 are substantially the same as in the example of FIG. 2. The cleaning system 300 further includes an adhesive roll 380, arranged to the remove contaminant from the outer surface 323 of the elastomeric roller 320, and a process roller 390 opposingly arranged with the elastomeric roller 320 to receive the sheet substrate 310 for cleaning.

The adhesive roll 380 is rotatably mounted within the cleaning apparatus 300. The adhesive roll 380 has a generally cylindrical outer surface, also known as an adhesive surface 383, arranged so that a portion of the adhesive surface 383 is in contact with a portion of the outer surface 323 of the elastomeric roller 320. The adhesive surface 383 is adapted to remove accumulated contaminants from the outer surface 323 as the elastomeric roller 320 and adhesive roll 380 rotate relative to one another. In this way, the adhesive surface 383 continually refreshes the outer surface 323 for optimal cleaning of the sheet substrate 310.

The process roller 390 is mounted within the cleaning apparatus 300. The process roller 390 has a generally cylindrical outer surface, known as a support surface 393, that is arranged to contact the second surface 314 of the sheet substrate 310 as it is received by the elastomeric roller 320. That is, the process roller 390 supports the sheet substrate 310 as it is engaged with the elastomeric roller 320.

The process roller 390 and the elastomeric roller 320 are opposingly arranged with a spacing, or nip gap, therebetween. Thus, the process roller 390 and the elastomeric roller 320 are arranged to respectively engage opposing portions of the first and second surfaces 312, 314 of the sheet substrate 310 as it is received by the apparatus 300.

In the example shown in FIG. 3, both the electromagnetic radiation source 340 and the detector 360 are positioned relative to the elastomeric roller 320 so that the predetermined region 325 is after engagement of the outer surface 323 with the sheet substrate 310. That is, as the elastomeric roller 320 rotates, the electromagnetic radiation source 340 and detector 360 are both provided operably between the nip gap and the adhesive roll 380. However, one or both of the electromagnetic radiation source 340 or the detector 360 may be arranged operably after the adhesive roll 380.

In this way it is possible irradiate the outer surface 323 of the elastomeric roller 320 prior to, or subsequent to, the cleaning of the elastomeric roller 320 by the adhesive roll 380.

The detector 360 is configured to receive a reflection 361 of the electromagnetic radiation 341 from the outer surface 323 of the elastomeric roller 320 in the same manner as the example of FIG. 1. Thus, a reflection 361 is received by the detector 360 in order to provide a direct analysis of the outer surface 323. The detector 360 is adapted to continuously receive a reflection 361 of electromagnetic radiation 341 from the outer surface 323 to provide a real-time analysis of the outer surface 323.

Optionally, the apparatus 300 may include a series of detectors, arranged in a manner as explained above, to provide an analysis of the relative cleaning performance of a series of predetermined regions extending across or around the outer surface 323.

Optionally, a controller (not shown) may be operably coupled to the detector in the manner of the controller 270 of the example of FIG. 2. In this way, a controller and an analysis of the radiation scattering characteristics of the outer surface 323 of the elastomeric roller 320 may be incorporated into the example shown in FIG. 3.

Referring now to FIG. 4, there is shown a fourth example apparatus 400 according to an aspect of the invention. Where the features are the same as the previous examples, the reference numbers are also kept the same, but with a “4” as the initial digit. In the example of FIG. 4, the elastomeric roller 420, electromagnetic radiation source 440 and detector 460 are substantially the same as in the example of FIG. 1. Both the electromagnetic radiation source 440 and the detector 460 are mounted to a housing 490. In this way, the relative orientation of the electromagnetic radiation source 440 to the detector 460 is maintained by the housing 490.

The housing 490 is adapted to move relative to the elastomeric roller 420. Thus, the housing 490 is adapted to scan the elastomeric roller 420 by scanning in a direction parallel to the elastomeric roller 420 axial length. Additionally, or alternatively, the housing may be adapted to scan the elastomeric roller circumferentially. In these ways, the relative orientation of the electromagnetic radiation source 440 and the detector 460 is maintained as they move relative to the elastomeric roller 420. Consequently, the fixed geometric arrangement of the electromagnetic radiation source 440 and the detector 460 ensures that accurate measurement of the reflection 461 by the detector 460 is maintained while moving.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract or drawings), or to any novel one, or any novel combination, of the steps of any method or process so disclosed.

It will be appreciated by persons skilled in the art that the above embodiment(s) have been described by way of example only and not in any !imitative sense, and that various alterations and modifications are possible without departing from the scope of the invention as defined by the appended claims. Various modifications to the detailed designs as described above are possible.

In certain examples, the invention may be defined by any one of the following numbered clauses:

Clause 1. Apparatus for evaluating an elastomeric roller surface, comprising:
an elastomeric roller, rotatably mounted within a contact cleaning apparatus such that an outer surface of said elastomeric roller contactingly engages a substrate surface;
an electromagnetic radiation source, configured to selectively emit electromagnetic radiation of a predetermined electromagnetic spectrum onto at least one predetermined region of said outer surface,
and a detector, configured to receive at least a first reflection of said electromagnetic radiation from said at least one predetermined region.
   Clause 2. Apparatus according to clause 1, further comprising a controller operably coupled to said detector and adapted to determine at least one characteristic parameter of at least said first reflection.
   Clause 3. Apparatus according to clause 2, wherein said at least one characteristic parameter is a radiation scattering characteristic of at least said first reflection from said at least one predetermined region.
   Clause 4. Apparatus according to any one of clauses 2 and 3, wherein said controller is adapted to monitor said at least one characteristic parameter and actuate an alarm signal when said at least one characteristic parameter deviates by a predetermined threshold.
   Clause 5. Apparatus according to clause 4, wherein said controller is adapted to monitor said characteristic parameter continuously.
   Clause 6. Apparatus according to any one of clauses 4 and 5, wherein said predetermined threshold is a maximum deviation from an initial value of said at least one characteristic parameter.
   Clause 7. Apparatus according any one of clauses 2 to 6, wherein said controller is further adapted to determine said at least one characteristic parameter from an intensity of at least said first reflection of said electromagnetic radiation from said at least one predetermined region.
   Clause 8. Apparatus according to any one of the preceding clauses, wherein said apparatus is operable to emit said electromagnetic radiation onto a plurality of predetermined regions of said outer surface.
   Clause 9. Apparatus according to clause 8 when depending on any one of clauses 2 to 7, wherein said controller is adapted to provide an average of said predetermined characteristic parameter determined from at least a first reflection from each of said plurality of different regions.
   Clause 10. A method of evaluating an outer surface of elastomeric roller, said method comprising:
using an electromagnetic radiation source to selectively emit electromagnetic radiation of a predetermined electromagnetic spectrum onto a predetermined region of said outer surface, and
using a detector to detect at least a first reflection from said predetermined region.
   Clause 11. A method according to clause 10, said method further comprising:
providing a controller operably coupled to said detector, and
using said controller to determine at least one characteristic parameter of at least said first reflection.

1. A contact cleaning apparatus, comprising:
an elastomeric roller, rotatably mounted within said contact cleaning apparatus such that an outer surface of said elastomeric roller is contactingly engageable with a substrate surface; and
an apparatus for evaluating said outer surface of said elastomeric roller, comprising:
an electromagnetic radiation source, configured to selectively emit electromagnetic radiation of a predetermined electromagnetic spectrum onto at least one predetermined region of said outer surface;
a detector, configured to receive at least a first reflection of said electromagnetic radiation from said at least one predetermined region; and
a controller operably coupled to said detector and adapted to determine at least one characteristic parameter of at least said first reflection.

2. A contact cleaning apparatus according to claim 1, wherein said at least one characteristic parameter is a radiation scattering characteristic of at least said first reflection from said at least one predetermined region.

3. A contact cleaning apparatus according to claim 1, wherein said controller is adapted to determine a surface roughness of said elastomeric roller based upon said at least one characteristic parameter.

4. A contact cleaning apparatus according to claim 1, wherein said controller is adapted to monitor said at least one characteristic parameter and actuate an alarm signal when said at least one characteristic parameter deviates by a predetermined threshold.

5. A contact cleaning apparatus according to claim 4, wherein said controller is adapted to monitor said characteristic parameter continuously.

6. A contact cleaning apparatus according to claim 4, wherein said predetermined threshold is a maximum deviation from an initial value of said at least one characteristic parameter.

7. A contact cleaning apparatus according to claim 1, wherein said controller is further adapted to determine said at least one characteristic parameter from an intensity of at least said first reflection of said electromagnetic radiation from said at least one predetermined region.

8. A contact cleaning apparatus according to claim 1, wherein said apparatus is operable to emit said electromagnetic radiation onto a plurality of predetermined regions of said outer surface.

9. A contact cleaning apparatus according to claim 8, wherein said controller is adapted to provide an average of said predetermined characteristic parameter determined from at least a first reflection from each of said plurality of different regions.

10. A method of evaluating an outer surface of an elastomeric roller for a contact cleaning apparatus, said method comprising:
using an electromagnetic radiation source to selectively emit electromagnetic radiation of a predetermined electromagnetic spectrum onto a predetermined region of said outer surface;
using a detector to detect at least a first reflection from said predetermined region; and
using a controller to determine at least one characteristic parameter of at least said first reflection.

11. A method according to claim 10, wherein said at least one characteristic parameter is a radiation scattering characteristic of at least said first reflection from said at least one predetermined region.

12. A method according to claim 11, wherein said radiation scattering characteristic corresponds to a surface roughness of said elastomeric roller.

13. A method according to claim 10, further comprising actuating an alarm signal in response to said at least on characteristic parameter deviating by a predetermined threshold.

14. A contact cleaning apparatus comprising:
an elastomeric roller rotatably mounted within said contact cleaning apparatus such that an outer surface of said elastomeric roller is contactingly engageable a substrate surface, and
an apparatus for evaluating a surface roughness of said outer surface of said elastomeric roller, comprising:
an electromagnetic radiation source, configured to selectively emit electromagnetic radiation of a predetermined electromagnetic spectrum onto at least one predetermined region of said outer surface;
a detector, configured to receive at least a first reflection of said electromagnetic radiation from said at least one predetermined region; and
a controller operably coupled to said detector, said controller adapted to determine, based upon said at least said first reflection, a surface roughness of said outer surface.

15. (canceled)
